(19) United States
(12) Patent Application Publication
(10) Pub. No.: US 2018/0268475 A1
(43) Pub. Date: Sep. 20, 2018

(54) Enabling a Personalized Conversation between Retailer and Customer at Scale

(71) Applicant: BILLIONAIRED LABS, New York, NY (US)

(72) Inventor: Samantha Ziskin, New York, NY (US)

(73) Assignee: BILLIONAIRED LABS, New York, NY (US)

(21) Appl. No.: 15/547,696

(22) PCT Filed: Feb. 19, 2016
(86) PCT No.: PCT/US2016/018661

§ 371 Date: Jul. 31, 2017

Related U.S. Application Data
(60) Provisional application No. 62/118,181, filed on Feb. 19, 2015.

(51) Int. Cl. G06Q 30/08; G06Q 30/02

(52) U.S. Cl. CPC G06Q 30/08; G06Q 30/0201; G06Q 30/0226; G06Q 30/0281; G06Q 30/0202

(57) ABSTRACT

The invention relates to the gathering of information from multiple sources: customer, retailer, and third parties with information affecting commerce. The invention further establishes communication that allows the offering to each customer an instantaneous dynamic price (IDP), reflecting constantly changing conditions in the market and the customer's profile and the retailer's business imperatives and allowing the customer to place bids in lieu or in addition to purchase at the IDP. This increases profit and/or transaction rate and makes the price equitable. The invention allows the processing of data that provides advisory content for retailer. Moreover, the invention creates a partner for the retailer, a partner that drives commerce by offering advice based on accumulated data and offers its own rewards to customers that use the equitable pricing system.

### BACKGROUND OF THE INVENTION

### Field of the Invention

This invention relates to the field of software designed to help businesses and customers communicate and transact purchases. It is both “Software as a Service” and a “Platform as a service” (SaaS and PaaS). It provides a means to collect the customer information that is minimally required to consummate a purchase and to collect additional customer information. It changes the customer's experience in real-time, shares real-time information with a retailer, uses data from multiple source types to derive demand curves and other data visualizations, and provides the ability to dynamically price and bid on items of commerce.

### Description of the Background

Both online and brick and mortar retailers benefit from collecting and analyzing customer data. Currently, that data is difficult to obtain. Brick and mortar retailers have resorted to door counters and heat maps. Using these methods, retailers are able to count people and know where, and for how long, they stand. This data is sometimes incorrect and is always incomplete. For example, imagine entering a store with your husband, friends, or your kids. Only you plan to purchase. The door counter counts everyone. It sometimes even counts store employees. The retailer needs to know who entered and why, not just how many. In the case of heat maps, one might learn that a customer spent 5 minutes standing in front of ladies' underwear, but would not know if that customer had genuine interest in the product or had, for example, found the ladies' underwear area a convenient place to take a phone call.

No current technology can determine how much a customer thinks an item is worth and how much she is willing to pay for it. No technology asks a customer what her ideal in-store experience would be and shares that in real-time with a retailer. No technology motivates a customer to provide data while giving options of sharing personal data, but only at her discretion.

Aside from the difficulties of collecting customer data, the industry suffers from another huge problem: discounting. Retailers have been trying to wean customers off discounting, but so far haven't been successful. Department store operator, J.C. Penny, attempted to stop discounting cold turkey around 2012. According to Harvard Business Review's “J.C. Penney's “Fair and Square” Pricing Strategy,” Ron Johnson, the then-new CEO of the company, initiated some major changes: a new pricing scheme he put in place, called, “Fair and square,” was a central component of the new strategy. The scheme initially had three pricing tiers and eliminated typical sales promotions in an attempt to simplify the shopping experience for customers; thus moving J.C. Penney off its previous high-low pricing practice. By eliminating the thrill of pursuing markdowns, the “fair and square every day” pricing strategy disenfranchised JC Penney's traditional customer base. Shoppers reacted poorly to the disappearance of coupons and sales. Throughout 2012, sales sagged dramatically. In the fourth quarter of the 2012 fiscal year, same-store sales dropped 32%, which led some to call it “the worst quarter in retail history.” On April 8, 2013, Ron Johnson was fired as the CEO of J. C. Penney and replaced by his predecessor, Mike Ullman (Ofek, Elie, and Jill Avery. “J.C. Penney's ‘Fair and Square’ Pricing Strategy.” Harvard Business School Case 513-036, September 2012. (Revised January 2013)).

Customers have been “trained” wrong; they look for deep discounts and don't offer feedback about the product, price, or their in-store experiences. Retailers may offer specials to incentivize buying in bulk or shopping at a time of low foot traffic, like “4 shirts for the price of 3” or “Tuesdays before noon are special for seniors. They receive 10% off.” A retailer may also offer a reward for customers who complete surveys. The paper, “Customers' Purchase Intentions and their Behavior,” states: “Purchase intentions are frequently measured and used by marketing managers as an input for decisions about new and existing products and services.” Unfortunately retail surveys are notoriously ineffective at gathering data. Purchase intentions and market research are “imperfect measures” of what consumers actually do. When customers are asked what a product is worth but they aren't bound to purchase it, their answers are usually lower than when they are in a realistic situation—bound to purchase the item (“Do People Always Pay Less Than They Say? Testbed Laboratory Experiments with IV and HG Values”). In the study “Do People Always Pay Less Than They Say? Testbed Laboratory Experiments with IV and HG Values,” hypothetical bias is explored. In some situations, people tend to overstate their preferences (i.e. state that they would pay more in a hypothetical situation than they would if the situation was real) when they do not experience the real monetary consequences of their decision (JACQUEMET, N., JOULE, R.-V., LUCHINI, S. and SHOGREN, J. F. (2011), Do People Always Pay Less Than They Say? Testbed Laboratory Experiments with IV and HG Values. Journal of Public Economic Theory, 13: 857-882.) Currently, it is difficult to forecast sales from purchase intentions measures, and difficult to know why purchase intentions do not always translate into sales (Vicki Morwitz (2014), “Consumers' Purchase Intentions and their Behavior”, Foundations and Trends® in Marketing: Vol. 7: No. 3, pp 181-230).

Providing retailers with binding customer bids is a far superior solution than giving retailers market surveys and estimated purchase intentions. Retail customers and retailers can't have personalized real-time conversation at scale. Enabling this conversation would make for a more efficient marketplace, produce better products and better customer experiences, and improved business methods. It would also allow retailers to partner with their customers to drive social impact.

### SUMMARY OF THE INVENTION

In one embodiment, the invention provides a method of applying equitable pricing to a transaction, comprising a platform which: identifies a Product ID for an item which a customer desire to purchase; collects customer information sufficient to process the transaction; at the option of the customer, collects personal information, which personal information the customer optionally chooses to share in part or in whole with a particular retailer; processes a real-time conversation between a customer and a retailer; produces and considers data comprising at least one data from among current inventory, demand curve, historic transaction velocity, seasonal sell cycle, any loyalty program between the customer and retailer and scraped data; establishes for the item an instantaneous dynamic pricing (IDP); offers the customer the item for purchase at the IDP price; allows the customer to purchase the item at the IDP price or to opt making a Bid and, optionally, to choose a time frame during which the Bid offer is standing; considers the Bid; process the transaction if the IDP price was accepted or if the Bid was successful; issues a purchase receipt; and stores the purchase information.

In one embodiment, the conversation is at scale, that is: it is in real-time; it allows the customer to, optionally and at customer's discretion, inform retailer of customer's preference of at least one from among in-store treatment (e.g. being addressed by first or last name, using a title, offering a drink), corporate issues of interest to customer, or personal profile of customer; and allows retailer to consider data before establishing the current IDP and the limits of a an acceptable, delayed or rejected Bid, which data comprises, for the item subject to transaction, at least one factor from among inventory, demand curve, bid curve, profit margin, competition data, customer profile.

In one embodiment, the retailer receives in real-time the customer's preference for in-store treatment, corporate issues of interest to customer, and/or personal profile, and allows a response, including, correspondingly, attending to in-store preferences, inform customer of corporate initiatives in line with the issues of interest to customer or inform customer of corporate donations to appropriate charities, include consideration of the personal profile to calculate IDP or Bid limits being accepted.

In one embodiment, the scraped data comprises at least one from among weather, time of day for the contemplated transaction, calendar in relation to sell cycles or holiday schedules commodity costs, and competitor behavior.

In one embodiment, in response to a Bid, the platform accepts the Bid, or delays acceptance of the Bid and may accept Bid within the time Bid offer stands, or reject the Bid.

In another embodiment, the customer is allowed to place a Bid either prior to receiving IDP information or after receiving the IDP information. In another embodiment, the customer is allowed to place a Bid for any item only 1, 2, 3, 4, 5, or 6 times within a predetermined time frame and the customer is allowed to purchase the item at IDP if bidding fails. Preferably, the customer is allowed to place a Bid only three times. In another embodiment the time frame within which a limited number of Bids are accepted is 6 hrs., 12 hrs., 24 hrs., 48 hrs., or 72 hrs., and the customer may rebid after expiration of the time frame limit.

In another embodiment, the receipt, original price, date of purchase and time of purchase are stored and made available to resale websites as documentation to support resale of the item.

In yet another embodiment of the invention, the platform does not produce and/or offer an IDP but the customer is informed of a price tag and the customer can opt to Bid and, optionally, to choose a time frame during which the Bid offer is standing.

In still another embodiment, a customer who purchases an item opts to have the item held for later pick up or delivery to a third party, and, optionally, the platform processes a transaction for payment from third party to customer.

In one embodiment of the invention, the IDP is optionally presented to a customer as a static information or as the information that changes in value over time.

Another embodiment of the invention provides a system for applying equitable pricing considerations to a transaction, comprising interaction between a platform hosting an alogarithm and data bases and a retailer's backend operations through a retailer's dashboard through an application program interphase (API), and interaction with a customer through an application, where the system implements two way communications with retailer and customer, and the information communicated allows establishing an instantaneous dynamic price and consideration of Bids made by customer for an item available for sale. In another embodiment, the retailer's dashboard allows visualization of data comprising advisory information, including demand curves, bid distribution information, number of items sold in a period of time, number of items for which a Product Id was established and what proportion ended in a sale, group items sold by type, brand or other classification and market trends.

In another embodiment of the system, the application for use by customer with the system is an Omni-channel application, i.e. hosted on mobile devices, personal computers, or accessible through the websites of the retailer, advertisement on media, and can be connected-to from home, street, or a store.

In one embodiment, the customer can sign up for the application in advance of a contemplated transaction or can be directed to the application from a retailer's website, after entering a product ID. In an embodiment, the two way communication with the customer allows the application to generate promotions, a usage reward points system, and games to increase the usage of the app by customer.

Yet another embodiment provides the algorithm on the platform learns and adjusts from its processes, which adjustments include at least one from changes to Sign Up to speed process or produce additional or remove personal information items, reweigh factors that determine the ADP, reconsider and optionally add new scrapped data items, collect information and compile trend information, which trend information may optionally be presented as trend information for specific social, gender or age groups.

In another embodiment, the process of interaction with customer is adjusted to allow studies of customer shopping behavior, or the effect of advertisement campaigns or retail policies.

### BRIEF DESCRIPTION OF THE DRAWINGS

FIG. 1 is a flow chart of the interaction of a customer with the application, leading to a successful bid. An example customer is named, “Chloe Otis.” FIG. 1A depicts the Dashboard. FIG. 1B shows the steps of customer Signup/Profile, the information the customer must provide as well as optional information. FIG. 1C depicts the step of Product Identification (Product ID). FIG. 1D shows Product Details including a picture, size, color, description, and the retailer's corporate social responsibility campaign. FIG. 1E shows Bid, Duration, and a representation of an algorithm. Figure IF shows the purchase being successfully consummated and the proof of purchase, a QR code. FIG. 1F also shows the Bids and Receipts.

FIG. 2 is a flow chart illustrating categories of information the algorithm receives and processes. Within each category, examples of data for that category are listed.

FIG. 3 is a graphic representation of the information on revenue and item profitability reflected in the bidding system data.

FIG. 4 is a graphic presentation of a demand curve.

### DETAILED DESCRIPTION

The invention enables a novel, at scale dialogue between retailers and their individual customers and enables and leverages equitable pricing to drive a more rewarding shopping experience. Data is collected from customer and from retailer and transformed into instantaneous dynamic pricing. Alternatively and/or additionally, bidding is allowed and the merits of a bid are based partially on the above conversation and partially on scraped data, all considered in tandem. The transaction data is compiled and serves as both a bookkeeping option for the retailer as well as advice for the retailer. Optionally, the invention calculates and decides whether to consummate a transaction. This decision may be made by the retailer through the platform of the invention or made by the algorithm based on guidelines from the retailer and real-time updates, e.g. inventory status. The transaction is recorded in a manner that supports later resale activity.

The invention implements a retail and customer personalized conversation, “at scale,” i.e. the ability for each customer to have a personalized conversation with a retailer about content such as price, product, experience, business methods, and values. “At scale” means that many individual conversations may be had concurrently. Moreover, the conversation is effective; it is not with an individual store employee with limited information and scope of duty. At scale means that a specific offer by a customer is considered in the context of the retailer's interest as the retailer's interest changes in real-time, e.g. available product stock, cost, profitability margin, season, desire to reward more valuable customers. At scale also means that the customer's preference of in-store treatment is made available to retailer in real-time, allowing for real-time response. At scale also means that a customer's interest in social values related to aspects of the retailer's business are noted and available for consideration and action by retailer. At scale also means that all these aspects of business information are obtained/considered/acted upon in practical real-time. The communication is “in real-time.” “In real-time” means that it is nearly instantaneous, within the limits of web and computer networks limitations. “In real-time” also has a functional definition: the information must be compiled and transmitted promptly enough to allow for practical use. For example, is in-store treatment preference (e.g. the customer does not want a store employee to approach her) communicated fast enough for a store employee to learn of the customer's preference (e.g. the store employee would see that the customer does not want to work with an employee and would leave the customer alone)?

The invention also implements “equitable pricing.” “Equitable pricing” means there is no one-size-fits-all price. A customer may communicate how much she is willing to pay and under what conditions. The resulting price, is her “personal price.” A retailer's unique business imperatives are weighed in real-time (e.g. available stock of the product, cost, demand curve, profitability margin, season, desire to reward valuable customers, desire to incentivize customer behaviors) and considered with the customer's offer and behaviors (e.g. affiliate marketing, shopping at a time of low foot traffic) to determine when and if a sale should be consummated. Moreover, the retailer's inputs and business imperatives change over time, as inventory, traffic, weather and other aspects change.

Each customer has her own maximum price she would pay for each item. For a blue dress that fits like a glove, Sarah would pay $100. Jessica might be willing to pay $72 for that same dress. For Ann, it's worth $0. Knowing each person is unique and each retailer has unique and changing business imperatives, it's most fair and most profitable for each transaction to be unique.

Equitable pricing is good for both customers and for retailers. To understand the advantage and workings of equitable pricing, consider that retail customers often think to themselves, “I'd like to buy that item, but it costs too much. If it were just priced a little lower, I would purchase it.” Retailers are often thinking, “I don't know exactly how much to price this item and if it doesn't sell, I'm not sure exactly when to decrease the price and by how much to decrease it.” Currently, retailers who can't sell a $1,000 suit plan a markdown, using the best predictive analytics they can. At first they may choose a 30% off sale. If the item still doesn't sell, the retailer marks the item down 60%. If it is still languishing on the rack, the retailer might resort to 80% off. Sales most often happen in discrete units of 10 or 15%. It's rare to see a sale for 72.5% off. Because retailers don't have an “at scale,” real-time communication with their customers (for example, the ability to ask a customer how much she would pay for an item and how long she would wait), a retailer has no idea if a customer would have paid more or less than the tagged price. A retailer may place that $1000 suit on sale for 80% off and a customer who would have paid a maximum of $380 might snatch it up, gleeful that she only paid $200. The retailer missed out on $180 because she couldn't determine how much that customer would have paid. On the flip side, with the invention, the customer can see that suit at any point in the sale cycle (e.g. the customer could see the item in a store when it newly arrived and was tagged at full price) and communicate her personal price and how long she was willing to wait. A decision is made using her inputs of personal price and wait period (this decision may also take into account various other personal factors, such as her Tweeting or her buying in bulk).

Moreover, equitable pricing increases the frequency of consummated transactions as all parties reach an acceptable and advantageous price and service equilibrium.

To use the invention, a customer must download an application (herein, sometimes, called an app) or sign up to a designated platform. If the customer does not have the app, she may sign up on a designated website or a retailer's website, by entering in personal information, payment method, and shipping method. For customers who use the app, purchases are made through one of two paths.

The first path begins with ingesting product identification information (herein, sometimes called “Product ID”). A preferred method of ingestion of Product ID is for the customer to scan the barcode of an item she wants to purchase. Barcodes may include matrix barcodes or UPC barcodes. Alternatively, she may scan another type of product ID, take a photo of the item that the system will identify, or manually input product identifying information like the catalog number). Product ID can occur anywhere; the customer may be in a store holding up the price tag to the phone, or in front of her home computer using her mobile device to scan the product code on the computer screen. Because the customers can use the invention in all channels (e.g. online and brick and mortar), the invention is referred to as an “omni-channel” solution. The invention is accessible through retailer websites, websites hosted by the owners of this invention, social media, and advertisements in print media.

Once the Product ID is obtained, the customer is presented with the current retail price and/or the instantaneous dynamic price and/or an invitation to bid.

The second path begins with the sign up page (“Signup/Profile”). In this path, the customer may proceed to purchase with a minimum of information: name, address, and payment information. Moreover, the customer is induced to provide additional personal information and/ or perform additional tasks. For example, the customer may input her children's clothing sizes or link her account to social networks. After the customer completes Signup/Profile with either the minimum required, or with additional information and tasks, she further chooses to make that information available (or not) to a particular retailer at the time of a transaction. For example, when the customer enters a store, she chooses to share all, some, or none of her data with the retailer. The amount of data she chooses to share may impact the pricing algorithm. For example, a customer who shares all of her data might have her equitable price multiplied times 0.95. A customer who shares some information may have her price multiplied times 0.98. A customer who shares no data would have her price multiplied times 1; she would receive no benefit. If the customer first enters Product ID, and she has not previously signed up for use of the application of the invention, she will be sent to the Signup/Profile page before she can buy the product. If customer has already signed up, she then follows the Product ID step onwards, to make a purchase.

After Product ID, the customer may choose to Bid. The Bid may optionally occur after the customer has seen the Instantaneous Dynamic Price (IDP), before she has seen the IDP, or alternatively when IDP is not provided; the Bid is in response to the tag price. When the customer is ready to Bid on an item, she enters the following:
1. Maximum price she is willing to pay (e.g. $999).
2. Optionally, she indicates the duration of time that her bid stands (e.g. “0 days,” or, until “March 25^{th}” or “I'm willing to wait 109 days from now.”)
3. Delivery mechanism and details (e.g. “I want my item shipped to 123 Main Street,” or, “I will pick my item up in the store.”)

This transaction/bid is binding if accepted, meaning that the sale is consummated if the invention's algorithm determines its acceptance or if the retailer determines the customer's offer is acceptable.

The platform allows that more than one item may be included in any order. If more than one item is included in an order, the pricing algorithm may reflect a benefit to buying in bulk. For example, buying 2 shirts may cause the algorithm to consider the bid value to be increased by 1.01 and so on. Customers such as TJ Maxx or Overstock.com may choose to purchase a lot. For example, Overstock.com might purchase 3000 tee shirts from GAP.

For customers who aren't already signed up, the flow works in much the same way, but begins with Product ID. This step may occur on a retailer's website, within the app, or on a separate website. The preferred method is to have the retailer use a logo on their website to allow connection to the solution provided by the invention. Alternatively, a customer's attempt to purchase the item from the retailer connects the customer to an outside website which hosts the invention and its algorithm. Customers click the logo and are taken to Signup/Profile which optionally appears in a pop up window or on a website designated to handle the invention's process. The customer then enters the same minimal information (if not signed up) and bidding information as they would with the app. Moreover, the customer chooses to enter (or not) personal information, and further chooses to make that information available (or not) to a particular retailer, at or before the time of a transaction. The rest of the process flow is the same as with starting the process directly from the app.

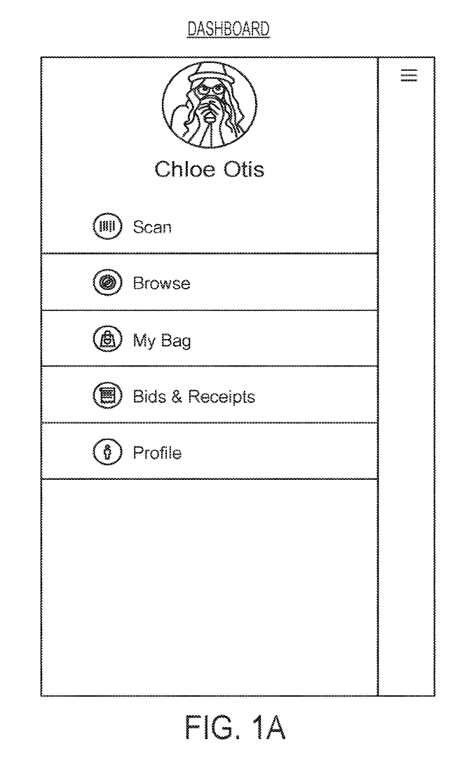

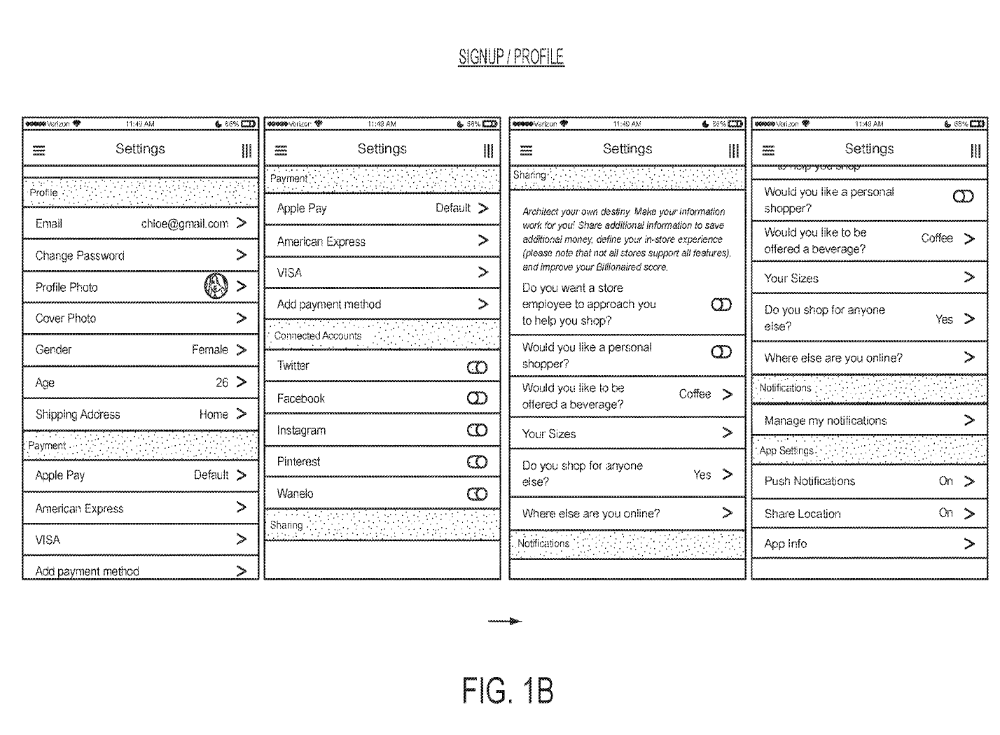

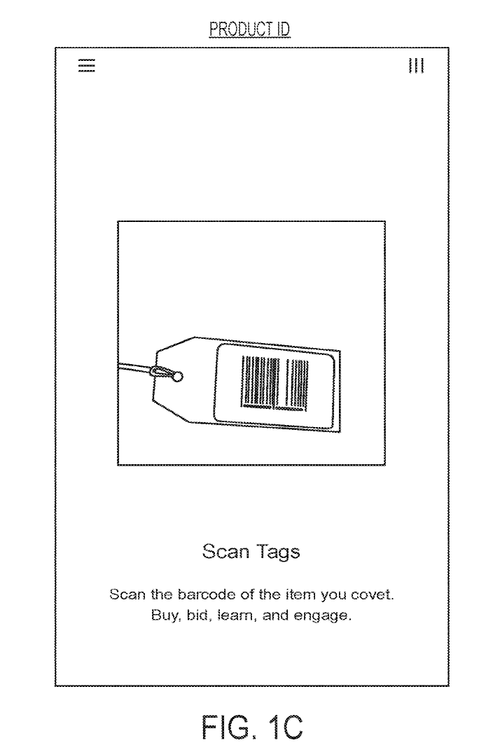

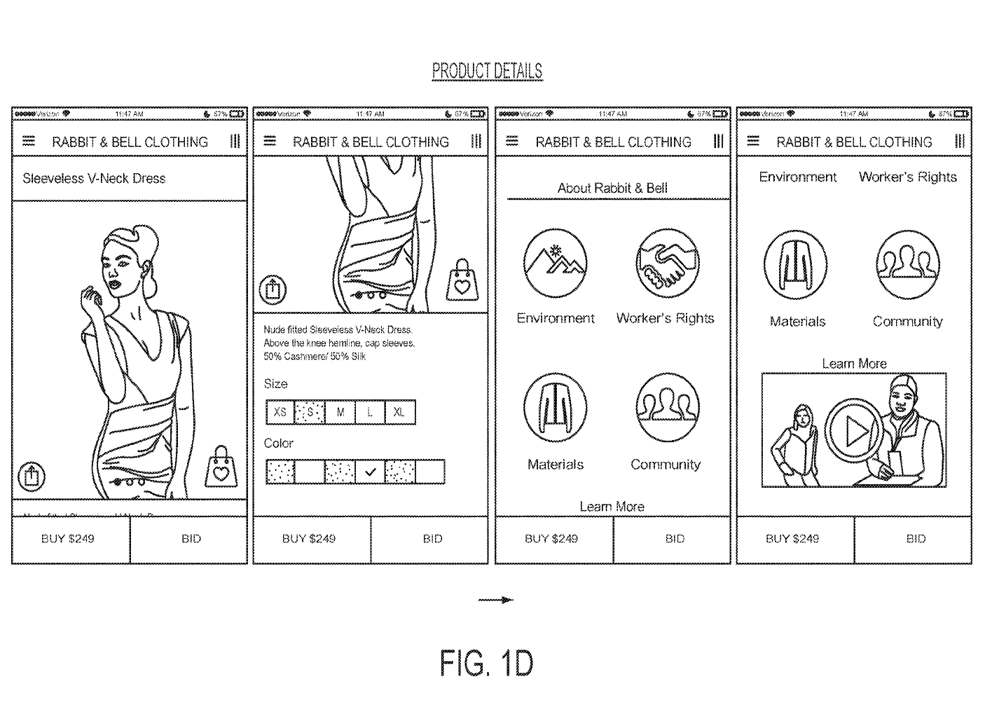

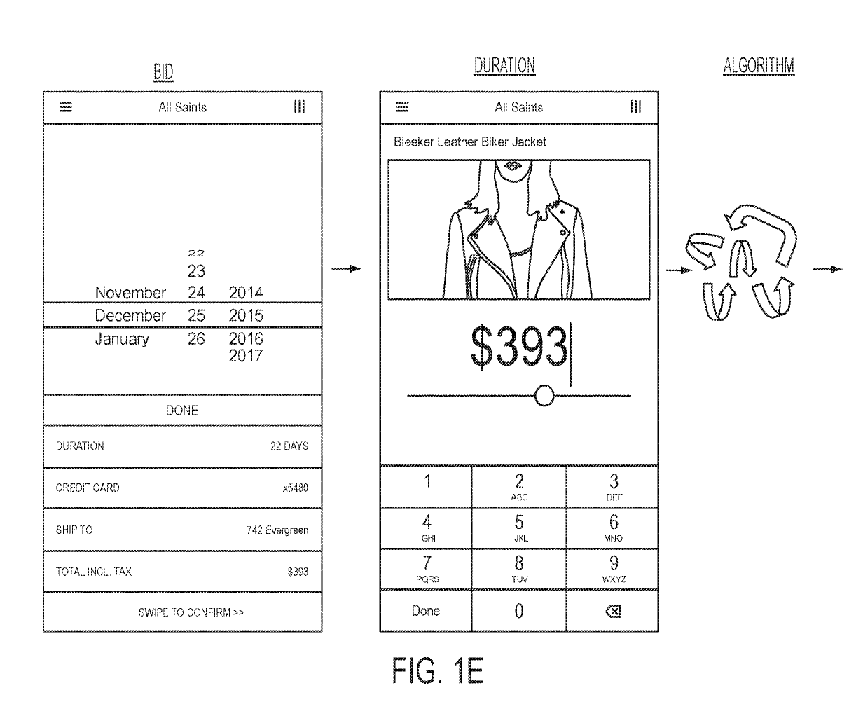

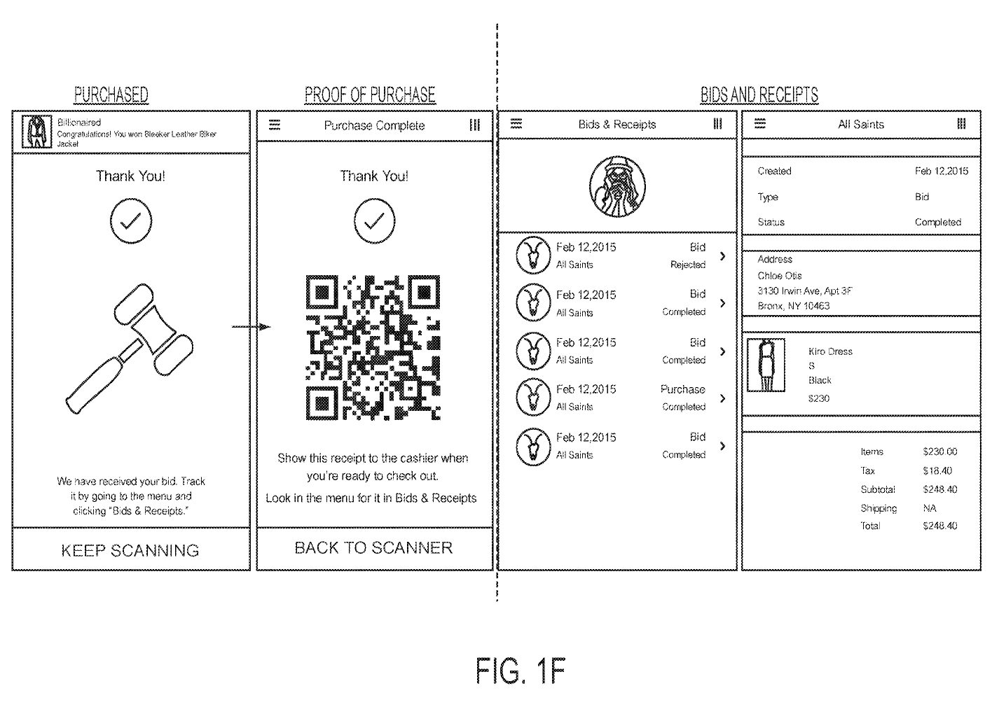

FIG. 1 illustrates the interaction between the customer and the application. In FIG. 1, the process starts with the customer first signing up for use of the application. As discussed above, the first two steps might be in reverse order, i.e. the customer may first identify a product (Product ID) and from there she can be directed to sign up for use of the application. FIG. 1A depicts the Dashboard, a “homepage,” for the customer to easily access the rest of the app. FIG. 1B depicts the Signup/Profile, where the customer enters various categories of information (personal, payment, social profile, preferences for in-store treatment). The specific info listed in the figure are just examples. As discussed herein-elsewhere, the information falls into two types, minimal info sufficient to process a transaction (e.g. credit card info and/or delivery address) and optional information (e.g. email and social media profile). FIG. 1E illustrates the Bid process steps. As discussed herein-elsewhere, optionally there is a Buy at IDP process, which the customer may choose to follow, instead of the Bid process.

The invention's algorithm considers inventory, retailer's goal margin, transaction velocity (rate of sales), unique customer data (e.g. purchasing frequency, how much personal data was shared), exogenous market factors (e.g. actual and expected weather), and a host of other factors (e.g. foot traffic and commodity costs) to determine if a purchase will be consummated at that moment, within the time-frame the customer specified in her bid, or not at all.

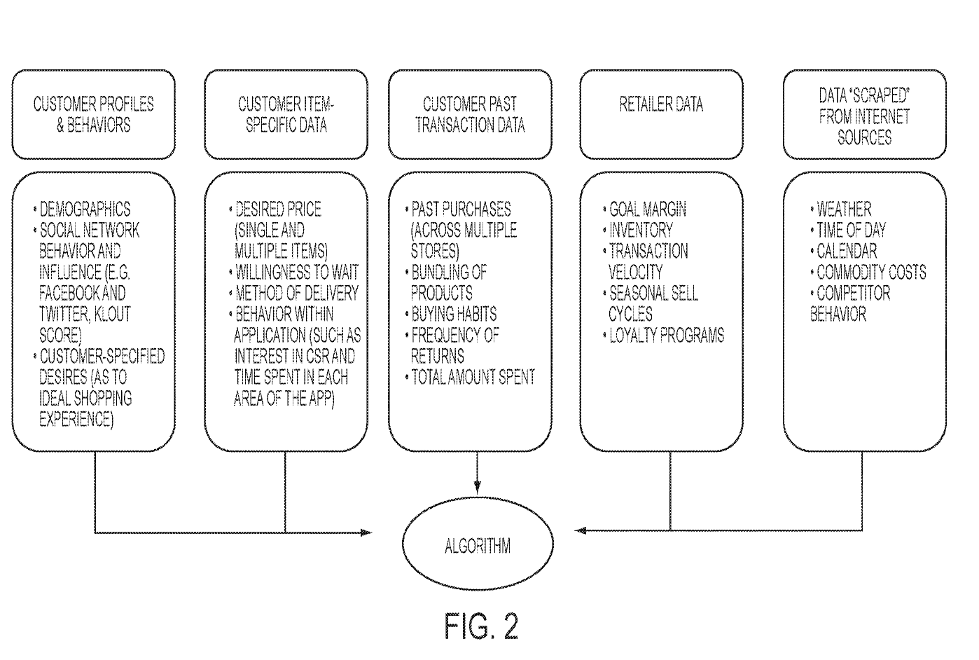

FIG. 2 breaks down the data the algorithm considers into distinct categories (Customer Profile and Behaviors, Item Data, Customer Past Transactions, Retailer Data and Scraped Data. Within each category, examples of the sort of data of that category are listed. Of notice, the information processed includes data from multiple sources (customer, retailer, invention's database, and Scraped Data). Some of the processed data is historical data (e.g., for retailer, the transaction velocity of past sales of the item; for customer past purchase history, etc.); some processed data includes retailer guided goals (e.g. profit margin, seasonal sell cycles); some data relates to the present offer to purchase an item; some data refers to the customer's social interests and “social worth.” “Social worth” is defined as a clients power to impact others to purchase. A high social worth is correlated with a customer being able to influence more people to purchase at higher prices. “Scraped Data” is relevant data collected from parties not involved in the transaction. Scraped Data may include actual weather, expected weather, time of day for the contemplated transaction, calendar in relation to sell cycles or holiday schedules, commodity costs, competitor behavior, or comparisons of like items.

The invention includes a universal customer-facing platform, which has an app that extracts data from customers, shares it with retailers, and facilitates a conversation between the two. The invention records the entire customer journey and data the customer volunteers when she signed up.

The invention's backend powers a network accessible API (application program interface), and a retailer's dashboard. It is able to synchronize/update to and from multiple retailers' backend systems. The invention's API is a service that enables its clients to interact with the backend system. Clients can include mobile devices like iOS and Android, as well as web sites. The invention synchronizes/updates to and from a retailer's backend system (examples of retailer's backend systems include Oracle, SAP, and Shopify) over a network in real-time. For example, if a retailer's inventory of an item changed, the invention's backend system will be notified in real-time of that change, e.g. there is one less winter coat. Similarly, if the invention needs to update a retailer's backend system of a change (e.g. a customer has just purchased a winter coat using the app), then the invention will have the ability to update the retailer's backend.

Among other things, the invention's API enables product information lookup by identification numbers such as product IDs, scanned barcodes, product photographs, or searches. It enables price lookups of varying types such as instantaneous dynamic pricing, bid rule-based, or algorithmic pricing. For example, the API may be used to access a retailer's price for a winter coat, their goal margin for the product category, “coats,” their initial cost, and the number of coats in stock. The numbers are then used, alongside other inputs, to both determine an instantaneous dynamic price and the algorithm to determine whether a customer bid should be accepted, denied, or placed in holding. In the winter coat example, the invention uses its API to determine that the retailer's coat price is $100, their goal margin is 250%, their initial cost was $20, and they have 2 coats in stock. The invention uses that information (among other information, e.g. competitor's prices and weather) to calculate an IDP of $94 and a bid algorithm that determines a bid of $85 is accepted. The API also enables customer account viewing/creation/modification/deletion, including any number of a customer's details (e.g. email address, social networks, in-store preferences, credit card information, and past purchases).

The retailer's dashboard is a network accessible interface that a retailer can optionally use to manage their interactions and settings with the invention. The retailer's settings may include pricing rules and unique business imperatives. An example of a setting is a retailer choosing to prioritize increasing foot traffic by lowering prices during the off-peak times. Another example is choosing to lower all prices by 1% each day until Christmas. Another example is allowing an 8% discount on any item that a customer with over 100 Twitter follower Tweets. An example of an interaction is a retailer choosing to be informed via push notification of a high value customer walking in the door, so every time a customer who spent over $7,500 in the last year enters the store, the retailer's dashboard displays customer details. The retailer's dashboard also enables product information management such as viewing/editing of individual products and entire sets of inventories. Optionally, the above-mentioned retailer's dashboard settings allow retailers to manage the pricing rules or algorithmic inputs that will affect their products. For example, a retailer using an Ipad displaying our dashboard chooses to change an algorithmic input under “commodity costs.” Previously the invention had been scraping data about the cost of cotton, which had spiked dramatically. The retailer did not want to pass on that commodity cost increase to her customers, so she set a rule to minimize the volatility.

The retailer's dashboard includes the optional use of any number of complex rules and control flow logic including data like internally available statistics (current inventory at a particular location) and external sources like weather forecast, or commodity price volatility. The retailer's dashboard will supply data visualization and statistical analysis of data processed by the invention. These can include number of items sold per day, location, brand, type, or number of scanned items purchased/not purchased, etc.

Optionally, the invention serves as payment processer and optionally or additionally interfaces with a banking system. The invention calculates and optionally directly deducts a portion of the sales proceeds of each transaction completed through the platform system, as payment for the use of the invention.

In one embodiment, the platform allows customers to lock in a personal price and sell that option to a third party. This feature is called, “commodity marketplace.” For a customer to use this feature, she must pay a fee in addition to entering her bid and duration. This fee may vary in relation to her bid and duration or be a fixed fee. If her purchase is consummated, she may then choose to keep the item, or sell it to a third party. For example, in March a customer sees a $1,000 coat that she believes is massively overpriced. She doesn't want to own that coat, but wants to capitalize on the fact that she thinks she thinks she can re-sell it at a higher price than the price she offered the original retailer. She bids $500 with a duration of 10 months. The retailer consummates the purchase after 2 months (in the Spring) and the customer is able to re-sell the item to a third party at $600. Optionally the retailer holds the item for the third party or optionally the customer receives the item and is responsible for giving it to the third party.

In one embodiment, the algorithm can partner with the customer who purchases an item and wishes to sell it to another, without taking possession. Upon instructions from buyer and for a fee, it collects the money from the second buyer and ships the item to the second buyer.

The platform of the invention also creates and stores its own reward points for customers using the system. Points are earned by consummating a successful purchase. They are calculated using total dollars spent and percent saved. For example, the platform logs a “point total,” equal to the greater of:
1. The cumulative dollars spent through the platform system; or
2. The product of: (1) a customer's average discount, (2) his or her number of purchases, and (3) 1,000.

The above formulas reward customer spending and savvy buying. Customers who cannot afford expensive items can still compete. For example, a customer who saves an average of 20% across 1,000 items will receive the same points and benefits (200,000) as a customer who spends $200,000.

Skilled betters, big buyers, and those with heart (customers may also earn points by offering feedback on corporate responsibility campaigns) will move up levels in the game. Each level of the game has rewards and/or increased transparency. For example, a customer who reached level 2 might be shown an item's transaction velocity or allow a customer to see exactly how much the algorithm weighted affiliate marketing. The invention allows customers to post their points on social media.

The platform includes a transaction history with receipts and respective product information (e.g. pictures, description, original cost) that allows exporting to sites for re-sale of the item, e.g. to eBay or as part of the commodity marketplace. The transaction history may also be exported for other purposes, such as personal accounting.

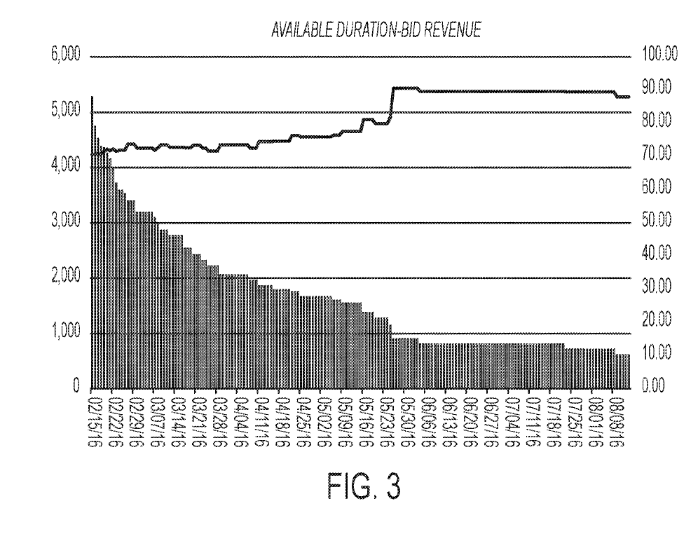

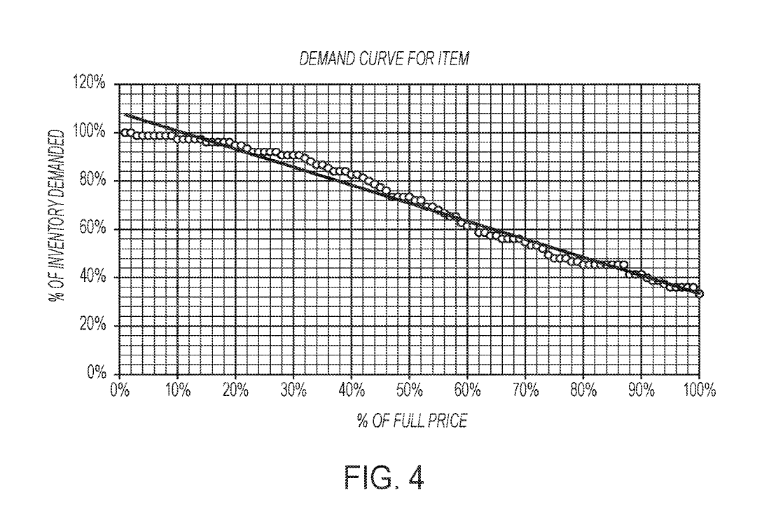

As noted above, the platform allows two-way interaction not only with the customer, but also with the retailer. Some of the information to/from retailer that is not directly a Bid or Buy order, nonetheless serves immediate purposes, e.g. inventory, traffic information, etc. that are relevant for immediate decision making. Some of information can also serve as a consultancy, information for longer-term decision making purposes. For example, the platform develops an understanding of fashion trends or color choices (specific for age groups or social profile groups). Other information can serve immediate purposes and planning purposes—see FIGS. 3 and 4 as examples.

FIG. 3 is a graph of a duration bid distribution. It is a snapshot of revenue available at a point in time through the bidding process for an item. For each date along the x-axis, the corresponding bar (plotted against the left vertical axis) shows the total amount of revenue a retailer would receive if it were to accept all available bids on a given item at a particular point in time. The line (plotted against the right vertical axis) shows the average price for those bids. For example, the data corresponding to the leftmost data could be read as, “As of Feb. 3, 2016, customers have committed to purchasing approximately $5,200 worth of this item at an average price of around $70 per item.” As time moves forward, the chart shows the retailer the revenue associated with expiring bids. Based on this information, the retailer can determine exactly how much revenue it is risking if it chooses to let bids expire, in the hopes of transacting at higher prices. For a given item, this chart will change in real-time as bids are received, accepted, and denied.

FIG. 4 is a representation of a demand curve. The graph is a plot of quantity demanded (on the y-axis, expressed as a percent of available inventory) as a function of price (on the x-axis, expressed as a percentage of full price). The graph is downward sloping because the quantity of the item demanded by customers decreases as the item's price rises. Each dot represents a unique customer offer on the items, and the black line is a linear fit of that data. One might read the bottom-rightmost point on the line as, “Approximately 32% of inventory could be sold at full price.” Similarly, the point corresponding to 50% on the x-axis indicates that approximately 70% of inventory could be sold at 50% of the full price. Presented in this manner, the data helps retailers price products more knowledgably, and gives them better insight into how inventory will move at different price points.

The invention incorporates artificial intelligence and machine learning. It is automatically and manually capable of adjusting and learning. For example, it collects data on the Signup process and makes changes to streamline and improve Signup/Profile. Fields that are consistently left blank by the customer may be eliminated or the text might be edited. Changes are based on direct feedback from customer as well as measurements of the process. For another example, it measures and assigns weights to the effect of various inputs into the logarithm: e.g. would skipping time of day information give a different result to the overall success of securing transactions?

Moreover, the algorithm can incorporate newly considered scraped data items. Further yet, the algorithm accumulates data on sales, bids, bid durations, preferences for colors and styles and the like, to create trend analysis data. Further yet, the algorithm enables studies of customers' shopping behaviors, by considering effects of the rewards system and modification, or static vs dynamic IDP presentation, or the effect of pushed advertising, behavior separated by social, gender, or age classes and so on.

The ability for the invention to learn results in an entirely customizable mobile experience. For example, Joe spends an average of $62 dollars when shown a corporate social responsibility campaign video that depicts factory workers, $31 when shown an environmental campaign, and only $8 when shown the retailer's control, a sexy blond model. In order to maximize spend and increase customer loyalty, the app begins showing Joe only the retailer's human impact campaigns.

### EXAMPLES

### Example 1

### A Customer Signup and Profile using the app

Existing app customers are greeted with the app's Start Page. When the customer touches anywhere on the screen, an event checks whether the customer is already signed up. If the customer has not previously signed up, the customer is transferred to the Signup. If they already signed up to use the invention, the customer is transferred to the Product ID screen. Of course, the Signup, Start Page, the Product ID page, and all other screens might have other names. For example, the Product ID page/step may be referred to as the Barcode Scan page.

At Signup/Profile, the following data fields, or equivalent, appear:
First name (blank alphanumeric field)
Last name (blank alphanumeric field)
Street Address (blank alphanumeric field)
City (blank alphanumeric field)
State (Drop down)
Zip Code (blank numeric field)
Credit card type (blank numeric field)
Credit card number (blank numeric field)
Credit card expiration (drop down date field)
Credit card security code (blank numeric field)
Shipping Address (blank alphanumeric field).

The fields below are optional and may appear on Signup/Profile page. Additional fields may be included.
Age (drop down)
Gender (drop down menu).

18
Your clothing sizes (drop downs)
If you shop for anyone else, please include include them here. This allows for customers to choose children, spouse, etc. (various drop downs)
Do you want a store employee to approach you to help you shop? (yes or no radio button)
If they choose “yes” to store employee help, the following appears, “How shall the employee address you?” (various drop downs)
If they choose “yes” to store employee help, the following appears, “Would you like a personal shopper?” (yes or no radio button)
Profile photo
Email
Password
Alternative payment methods
Connected Social Media Accounts
Where else are you online?
Share location setting (yes or no radio button)
Default Sharing of personal information (how much personal information do you want to share with retailers—all, some, or no data)
Push notification setting (yes or no radio button)
App preferences and information. Customers may set volume, toggle the interface between gambling game and simple. This also includes app information, such as version number.

Aside from collecting information such as the above, the application collects product meta-data, e.g. product color, whether the product has a zipper, season, specs. Optionally, in a feedback section, the customers can provide feedback, e.g. what changes they would make to the store, product, or business practices.

A button on the bottom of the screen may read “Finished!” or “Submit” or equivalent. The collected information is saved in the database. In addition, the database collects app customer statistics to optimize the app, such as how many attempts it took customers to fill out form, how long it took to fill the form.

At the Finished click, the app checks if there are incomplete fields and checks how many times the customer has attempted the form. If the data fields were incomplete once, the screen returns the incomplete field(s) and should read “Please choose a city and state,” “fill in your name” or refer to whatever field was incomplete. If data is incomplete more than twice, the following message should appear: “Please call us to assist you! Here's our number ______.” A “Finished” button appears at the bottom. Clicking “Finished” returns customer to the ProductID page. If the customer is using a cell phone, the phone's camera is enabled to scan a ProductID. Alternatively, the customer enters ProductID information, e.g. a catalogue number.

### Example 2

### Use of the algorithm to determine an Instantaneous Dynamic Price (IDP)

After Product ID has been successfully entered, the algorithm determines the Instantaneous Dynamic Price (IDP) of the chosen item. Inputs of the algorithm are determined in partnership with the retailer. Each item (or items) may have a different algorithm. Considerations in deciding the IDP include:

1. Price is based off how close product is to expiration (e.g. “expiration” might be defined as the end of the fashion season).

2. Price is based off supply in store (e.g. How many X-Large Blue V-neck Tee-Shirts are left on the rack and in that store's backroom?)

3. How many of the item does the retailer have at its other locations?

4. Consider foot traffic patterns. If there is an after-work rush to the mall, the prices will surge.

5. Consider other external factors. How would an impending storm impact the price of charcoal and peanut butter? What happens when Celebrat Sally is spotted wearing a dress sold in your store?

6. Consider the past reactions of the individual customer. Historically, have they bid more when there was a large price discrepancy between the IDP and tagged price or did they abandon the product?

7. Competitor prices of the same or similar items.

### Example 3

### Use of the Algorithm to Consider Bids

After the step, Product ID, the invention collects information such as the following from the retailer and the customer.

1. Which item was scanned

2. The purchase price

3. Date

4. Time

5. Store Address

6. Size

7. Color

8. Style

9. Season

10. Any other product meta-data details (sleeve length, roomy fit, cloth type).

11. Customer name

12. Age

13. Address

14. Gender

15. The price tagged

16. The instantaneous dynamic price.

The customer is presented with Product Details. Optionally, Product Details include a picture of the item, a text description, tagged price, the number of items in stock or accessible online, specs, size, how it was made, and/or color. Optionally, the Product Detail Page includes a retailer's corporate social responsibility campaign(s) or some other material of the retailer's choosing (e.g. a picture of a sexy blond model). The Product Detail page includes a “Bid” button and optionally, additionally includes the IDP button. The customer may bid by clicking the Bid button. An event then checks if the customer had previously bid on that same item. If the customer has bid within the past 30 minutes and has already bid three times, the customer is blocked from bidding again. A text to the following general effect is displayed on the device the customer uses: “You already bid on this item. You can't bid again, but you can buy it now at “$IDP!” It should be clear that the limit of three bids in 30 minutes is just an example. The algorithm may choose to block further bidding after 1, 2, 3, 4, 5, 6, 7 bids and may allow new bidding after the limit of bids is reached with a delay in time. The delay may be about 30, 60, 120, 180 minutes, or 6 hrs., or 12 hrs., or 1 or 2 days.

If a bid is allowed, the customer is taken to the app's “Bid” page. The customer then chooses the amount of money she wishes to bid, her personal price. For example, she may enter “$50.” After she enters her price, she is taken to the app's “Duration” page. The customer then chooses the amount of time she wishes her bid to stand. For example, she may enter “19 days.” The app's pages may be combined or split up. For example, the Bid and Duration could be offered on the same screen. The above is simply an example.

The Instantaneous Dynamic Price (IDP) could potentially vary second by second, stay static with a 5 second window, increase, then decrease, etc. A choice as to the presentation of the IDP in a static or fluctuation manner will be influenced by historic customer data determining which rates and patterns most incentivize an individual to consummate a purchase and to spend the maximum amount. When customers first use the app, they may receive different patterns and rates (e.g. a static IDP, a log function, an increase, a decrease followed by a sharp increase, etc.). For example, from historic app use it is noted that Joe only makes a purchase when the IDP is static. Over time, his app will learn to give him a static price. Conversely, Sarah is most incentivized to buy when she sees an increasingly high price followed by a plateau. The app learns to display a slow 8 cent increase of IDP followed by a 10 second plateau.

### Example 4

### The Algorithm Iteracts with the Customer and the Retailer

After the IDP determination, the customer may purchase the item at the IDP or choose to bid. If the customer purchases the item at IDP, the item is added to the shopping cart. Data is sent to the retailer's backend system and data is sent to the invention's database.

The retailer gets the following data:

1. Which item was purchased

2. Purchase price

3. Amount the retailer should remit as payment for the process to the invention's owner or licensee.

4. The register must be notified in real-time so the store can remove the security tag (if desired) and print receipt (if desired).

5. The item must be subtracted from the retailer's inventory.

6. The app offers proof of purchase on the customer's mobile device or posted to her account. Optionally this can be in the form of a QR code which a retailer can scan.

The invention's database optionally receives the following information (they may also receive additional information):

1. Which item was purchased

2. The purchase price

3. The amount the store should remit for use of the invention

4. Date

5. Time

6. Store Address

7. Size

8. Color

9. Style

10. Any other product details that can gather (sleeve length, roomy fit, cloth type).

11. Customer unique identifier (this may optionally be a numerical code that is created upon customer Signup that will be used to uniquely identify each customer).

12. Age

13. Address

14. Gender

15. How many bids did the customer use, or did they buy it now?

16. The price tagged

17. The instantaneous dynamic price.

If the customer clicks, “Bid,” another event will happen, capturing the above info, and whether this is the customer's first, second, or third bid (and how many bids they had total).

This click also brings the customer to the Bid then Duration screen. On the Bid screen, the customer is presented with a scrolling bar that they can move to their chosen personal price. They may also optionally enter their chosen price using digits from a keypad. Optional text can read, “Bid and choose the maximum amount of time you're willing to let your bid stand. Remember, your bid is binding up to the date you choose.” On the Duration screen, the customer may choose the amount of time by typing with a keypad or optionally by scrolling through a calendar. Optionally the personal price will begin at 1 penny less than the IDP and go to 0 (this can optionally be customized for different retail partners). The customer is incentivized to choose a reasonable price because she does not want to waste time and knows she has only a limited number of bids.

In this example, the customer is allowed a maximum of 3 bids (this includes the customer entering her personal price and her duration). After the customer bids and chooses duration, that data is compared with bidding algorithms. These “Bidding Algorithms” are distinct from the algorithms discussed earlier, the ones used to calculate the IDP. Using the bidding algorithms, bids are placed into three categories:

1. Accepted for purchase now.

2. Accepted to the “bids in holding,” where the customer might win her item sometime within the duration she specified.

3. Denied [because the customer has bid too low].

The bid ranges that constitute a winning bid or a bid in holding are created based on information such as a retailer's cost and unique business imperatives, among other inputs.

One example of the result of a bidding algorithm is “Hard Floor.” In Hard Floor, the purchase is denied; no matter what that customer has chosen for duration; the price is never getting that low. If the bid is less than or equal to the Hard Floor Number, the Rejected Bid notification reads, “Your bid is too low. Would you like to try again? You get up to 3 bids.” A “bid again” and “no thanks” button also appear. “Bid again” returns the customer to the Product Details page or alternatively to the Bid page. “No thanks” returns the customer to the ProductID page. At the third bid, the text reads, “This is your final chance to bid on this item. Choose wisely. Try something closer to the IDP.” If the customer fails to consummate the purchase after three times, they are brought back to the Product Details page or alternatively to the Bid page, but the “bid” button is gone. The text reads, “You can still buy your item at the IDP.”

A second example of the result of a bidding algorithm is “Bids in Holding.” If the first, second, or third bid is greater than the “Hard Floor” (but not sufficiently high to produce an immediately Accepted Bid), the bid is accepted in a “bids in holding” area of the invention's database. The customer is greeted with, “You're so close to getting your item! It's possible your item will come to roost in your closet in x days (i.e. the duration the customer selected) ______! If you don't want to try your luck, you can still choose to “Buy it at the IDP.” There are two buttons: “IDP” and “Wait it out.” If customer chooses “wait it out,” a fun graphic dances along the screen, followed by the ProductID page, or alternatively the Bids and Receipts page. The “bids in holding” are effectively “put options.” Collecting a number of these “put options” allows the invention to build demand curves and forecast revenues.

A third example of the result of a bidding algorithm is “Bid Accepted” (a winning bid). In this result, a bid is accepted instantaneously. This result could be caused by a bid that was sufficiently close to the IDP (“sufficiently close” is a value predetermined by the retailer's inputs and considered with other factors).

An event takes place after each bid, capturing the above info, the bid amount, and whether this is their first, second, or third bid (and how many bids they had). This info will be used to optimize the algorithm bidding process. It also provides an opportunity to study the psychology of the customer.

For customers who are buying more than 1 item, the algorithm includes a “Bundling” feature. Bundling allows customers to obtain discounts by purchasing more than 1 item. It considers all the items in the shopping cart and runs an algorithm that offers an IDP for the total cart (which may be better than the deal for each individual item). Customers can also bid on all the items in the cart. The customer flow is the same as bidding for individual items.

### Example 5

### After a Purchase or a Successful or Pending Bid

After a purchase is consummated, the next screen reads: “You're all done! If you'd like to give the store feedback, press here. Otherwise, your purchase is complete.” Feedback and “continue shopping” buttons are located at the bottom of the screen. “Continue shopping” brings the customer to the Dashboard page.

The Dashboard page (seen in FIG. 1A) includes the following:

1. Scan (this is the ProductID page)

2. Browse (this leads to retailer provided material or advertisements)

3. My bag (this is today's shopping bag of items)

4. Bids and Receipts page (this includes “Bids in Holding” and past purchase history and receipts)

5. Signup/ Profile page

6. Power and Green Points. This shows the amount of points and game level. Customers may also post to twitter, Facebook, etc. from here.

The Dashboard is accessible through an icon on the upper left of every screen.

By clicking on “Bids in Holding,” the customer is able to increase pending bids and increase/decrease duration. This page can be accessed at any time.

The invention described above should be read in conjunction with the accompanying claims and drawings. The description of embodiments and examples enable one to practice various implementations of the invention and they are not intended to limit the invention to the preferred embodiment, but to serve as a particular example of the invention. Those skilled in the art will appreciate that they may readily use the conception and specific embodiments disclosed as a basis for modifying or designing other methods and systems for carrying out the same purposes of the present invention.

The Applicant uses “she,” “her” and “customer,” “purchaser” or “client” interchangeably. Unless clearly indicated otherwise in the context, that is only a shortcut, a convenience for expression. The customer in the present invention can be of any gender, or, for that matter, can be an entity making purchases—it is not limited to a female gender customer or client.

All references, including publications, patent applications, patents, and website content cited herein are hereby incorporated by reference to the same extent as if each reference were individually and specifically indicated to be incorporated by reference and was set forth in its entirety herein.

The use of the terms “a” and “an” and “the” and similar referents in the context of describing the invention are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any non-claimed element as essential to the practice of the invention.

I claim:

1.A method of applying equitable pricing to a transaction, comprising a platform which:
identifies a product which a customer desire to purchase and collects customer information sufficient to process the transaction and, at the option of the customer, collects personal information, which personal information the customer optionally chooses to share in part or in whole with a particular retailer,
processes a real-time conversation between a customer and a retailer,
produces and considers data comprising at least one data from among current inventory, demand curve, historical data, transaction velocity, seasonal sell cycle, any loyalty program between the customer and retailer, scraped data, customer's desired price, customer's willingness to wait for the product, method of delivery, past purchases by customer, bundling of products, customer's frequency of returns, and total amount spent by customer,
establishes for the item an instantaneous dynamic pricing (IDP),
offers the customer the item for purchase at the IDP price,
allows the customer to purchase the item at the IDP price or to opt to making a Bid and, optionally, to choose a time frame during which the Bid offer is standing,
considers the Bid,
process the transaction if the IDP price was accepted or if the Bid was successful, and
issues a purchase receipt; and
stores the purchase information.

2. The method of claim 1, where the conversation is at scale, that is: it is in real-time;
it allows the customer to, optionally and at customer's discretion, inform retailer of customer's preference of at least one from among in-store treatment (e.g. being addressed by first or last name, using a title, offering a drink), corporate issues of interest to customer, or personal profile of customer; and allows retailer to consider data before establishing the current IDP and the limits of a an acceptable, delayed or rejected Bid, which data comprises, for the item subject to transaction, at least one factor from among inventory, demand curve, bid curve, profit margin, competition data, customer profile.

3. The method of claim 2, where
the retailer receives in real-time the customer's preference for in-store treatment, corporate issues of interest to customer, and/or personal profile, and
allows a response, including, correspondingly, attending to in-store preferences, inform customer of corporate initiatives in line with the issues of interest to customer or inform customer of corporate donations to appropriate charities, include consideration of the personal profile to calculate IDP or Bid limits being accepted.

4. The method of claim 1, where the scraped data comprises at least one from among weather, time of day for the contemplated transaction, calendar in relation to sell cycles or holiday schedules, commodity costs, and competitor behavior.

5. The method of claim 1, where, in response to a Bid, the platform accepts the Bid, or delays acceptance of the Bid and may accept Bid within the time Bid offer stands, or reject the Bid.

6. The method of claim 1, where the customer, is allowed to place a Bid either prior to receiving IDP information or after receiving the IDP information.

7. The method of claim 1, where the customer, is allowed to place a Bid for any item only 1, 2, 3, 4, 5, or 6 times within a predetermined time frame; the customer is allowed to purchase the item at IDP if bidding fails.

8. The method of claim 1, where the customer, is allowed to place a Bid only three times.

9. The method of claim 8, where the time frame within which a limited number of Bids are accepted is 6 hrs., 12 hrs., 24 hrs., 48 hrs., or 72 hrs., and the customer may rebid after expiration of the time frame limit.

10. The method of claim 1, where the receipt, original price, date of purchase and time of purchase are stored and made available to resale websites as documentation to support resale of the item.

11. The method of claim 1, where the platform does not produce and/or offer an IDP, the customer is informed of a price tag and the customer can opt to Bid and, optionally, to choose a time frame during which the Bid offer is standing.

12. The method of claim 1, where a customer who purchases an item opts to have the item held for later pick up or delivery to a third party, and, optionally, the platform processes a transaction for payment from third party to customer.

13. The method of claim 1, where the IDP is optionally presented to a customer as a static information or as the information that changes in value over time.

14. A system for applying equitable pricing considerations to a transaction, comprising
interaction between a platform hosting an algorithm and data bases and a retailer's backend operations through a retailer's dashboard through an application program interphase (API), and
interaction with a customer through an application,
where the system implements two way communications with retailer and customer, and the information communicated allows establishing an instantaneous dynamic price and consideration of Bids made by customer and willingness by customer to wait for an item available for sale,
where the retailer's dashboard allows visualization of data comprising advisory information, including demand curves, bid distribution information, number of items sold in a period of time, number of items for which a Product Id was established and what proportion ended in a sale, group items sold by type, brand or other classification and market trends.

15. (canceled)

16. The system of claim 14, where the application for use by customer with the system is an Omni-channel application, i.e. hosted on mobile devices, personal computers, or accessible through the websites of the retailer, advertisement on media, and can be connected-to from home, street, or a store.

17. The system of claim 16, where the customer can sign up for the application in advance of a contemplated transaction or can be directed to the application from a retailer's website, after entering a product ID.

18. The system of claim 14, where the two way communication with the customer allows the application to generate promotions, a usage reward points system, and games to increase the usage of the app by customer.

19. A platform as the platform in claim 1, where an algorithm learns and adjusts from its process, which adjustments include at least one from changes to Sign Up to speed process or produce additional or remove personal information items, reweigh factors that determine the IDP, reconsider and optionally add new scraped data items, collect information and compile trend information, which trend information may optionally be presented as trend information for specific social, gender or age groups.

20. The platform of claim 19, where the process of interaction with customer is adjusted to allow studies of customer shopping behavior, or the effect of advertisement campaigns, or retail policies.
